(19) United States
(12) Patent Application Publication
(10) Pub. No.: US 2021/0090027 A1
(43) Pub. Date: Mar. 25, 2021

(54) SYSTEM AND METHOD FOR COMPUTING COMPATIBILITY RANKED LIST USING INTELLIGENT CAPABILITY MATRIX

(71) Applicants: Sameer Kishor Agashe, Pune (IN); Sandeep Prabhakar Barve, Pune (IN)

(72) Inventors: Sameer Kishor Agashe, Pune (IN); Sandeep Prabhakar Barve, Pune (IN)

(21) Appl. No.: 16/633,687

(22) PCT Filed: Jan. 15, 2018
(86) PCT No.: PCT/IN2018/050020

§ 371 Date: Jan. 24, 2020

(30) Foreign Application Priority Data
Jul. 25, 2017 (IN) 201721026335

(51) Int. Cl. G06Q 10/10; G06Q 30/08; G06F 16/2457

(52) U.S. Cl. CPC G06Q 10/105; G06N 20/00; G06F 16/24578; G06Q 30/08

(57) ABSTRACT

Disclosed is a system (100) and a method (200) for computing compatibility ranked list using intelligent capability matrix. The intelligent capability matrix comprises a set of pre-defined parameters that considers demonstrated capabilities to distinguish, identify and validate aspects of capabilities and complexities, for example, for an employer and a candidate. The method (200) performs intelligent mapping of skills and experience of the candidate to a capability grid of the employer followed by quantification of the intelligent mapping between the candidate and role requirements to find a best match between them. The intelligent mapping allocates differential weights to various set of aspects of the employer and the candidate based on historical data. The system (100) and the method (200) is time and cost effective and reduces dependency on resume and JD.

The present disclosure claims priority from the provisional patent Reference Number: 201721026335/Application No: TEMP/E-1/26298/2017-MUM, filed on Jul. 25, 2017, and all the contents of the provisional application are included herein.

### FIELD OF THE INVENTION

The title generally relates to the field of matchmaking wherein the matching between two entities, a first entity having a set of requirements for commodity or/and services and the second entity having corresponding commodities and/or services, is done. The present invention relates particularly to an enhanced and intelligent method and system of enabling quantification and mapping of compatibility between the employer needs and the aspects offered by the candidate/employee.

### BACKGROUND OF THE INVENTION

In the prior art, various applications using Job Descriptions (JD) from the employer and Resume or Bio Data or Curriculum Vitae (CV) of a candidate are described.

Both being descriptive and generic in nature, the match making throws up multiple matches and the uniqueness of the job vis-a-vis the precise personal capabilities, may get lost in the process. Essentially these matches are dependent on textual data. There are several references of job portals where a combination of academic history along with role and years of experience of the candidates are used to search through and shortlist candidates for a set of pre-defined characteristics and staffing requirements and JD for multitude of professional institutions and businesses. “monsterjobs.com”, “indeed.com” and other portals essentially do these functions. Amongst other patents, US20140122355 A1 teaches identifying candidates for job openings using a scoring function based on features in resumes and job descriptions.

Many other references also present the AI/machine learning based searching that is a way of sifting through the candidate data and the JD data, to do the matching faster, better and more efficient. This could be done using keywords, or using social media profiles based information of the candidate. An example of this methodology is “glider.ai”. Yet another set of references present solutions/portals based on standard templates and run algorithms to match JDs with the candidate CV or Resume. As an example of a portal, “sourcedirection.com” presents an efficient method. As an example, U.S. Ser. No. 09/188,422, teaches a method for matching job candidates with employers where skills matrix are described and use of resumes is suggested.

Based on the above, three prevalent practices and their present limitations are given below:

Firstly, doing searches for matching key words and phrases between JD and resumes/CV is a common practice. Large number of CVs get shown matching for a job since both parties use keywords with lot of subjectivity and significantly varying interpretation about the breadth and depth of each capability.

Secondly, search inferences are derived by programmatically reading through candidate profiles based on intelligent algorithms. Suggestive matches make use of descriptive data from candidate profiles (obtained from sources such as CV, resumes, social media profiles etc.) and match against keywords/descriptions specified in the JD. Probability of best fit remains low due to inferential nature of the search and coarse level of granularity.

Thirdly, alternate methods like Candidate Video interviews/introductions, Chatbot based Q&A and AI based tests and assessments have been developed for specific instances and customized solutions are in place in few other cases. However, attributes of candidate selection are not standardized across candidates, companies and industries.

In view of the above three problems, there is a need to reduce subjectivity and dependence on inferences drawn using descriptive sources of data and keywords of varying interpretations. It is desirable to objectively analyze a candidate's capabilities in specific context of a JD using a set of common parameters used by both the candidate as well as the company.

Also, there are no references in the prior art whereby an intelligent mapping is done that is adaptable and flexible enough to allocate differential weights to various aspects of either the JD or the credentials of the candidate based on historical data. Further, drawing upon patterns within and across industries is also not observed in the prior art.

### OBJECTS OF THE INVENTION

It is an object of the present disclosure to provide a system for computing a compatibility ranked list for an application using an intelligent capability matrix. It is another object of the present disclosure to provide a method for computing a compatibility ranked list for an application using an intelligent capability matrix. It is yet another object of the present disclosure to provide a system and a method for identifying a best-fit candidate for a job opening by performing intelligent searching and mapping.

### SUMMARY OF THE INVENTION

The present disclosure presents a method and a system for computing a compatibility ranked list for an application with a corresponding system of superset of aspects with different granularities. The system describes a plurality of first entity having a first set of aspects selected from the superset of aspects, and a plurality of second entity having a second set of aspects selected from the superset of aspects, wherein the plurality of first entity and the plurality of second entity are associated with the application. The system further describes a first aspect matrix system using the different granularities of the first set of aspects of the plurality of the first entity, and a second aspect matrix system using the different granularities of the second set of aspects of the plurality of the second entity. As per another aspect of the disclosure, an intelligent searching and mapping system is functionally coupled to both the first aspect matrix system and the second aspect matrix system, that is used to compute scores, and a compatibility ranked list system uses the computed scores to generate the compatibility ranked list.

As per yet another aspect of the disclosure, a historical data system is described comprising historically stored data comprising the first set of aspects with corresponding granularities, the second set of aspects with corresponding granularities and superset of aspects with different granularities corresponding to the application. A pre-determined weights system of providing pre-determined weights for both: the first set of aspects and the second set of aspects, is also described. As per another aspect of the system the first set of aspects, the second set of aspects and the corresponding granularities, and the pre-determined weights for both sets: the first set of aspects and the second set of aspects, are obtained using either external data, the historical data system or an expert system. Another aspect of the system describes the intelligent searching and mapping system that can use methods selected from statistical methods, numerical methods, expert systems based methods, artificial intelligence based methods, machine learning methods and any combination thereof.

In yet another aspect of the disclosure, a method and a system for computing a compatibility ranked list, for at least an employer and at least a candidate of an industry, the system comprising at least a processor and a memory, wherein the memory and the processor are functionally coupled to each other, is described. The system further includes an industry specific areas of work system, corresponding to the industry, and also a capabilities system deriving from the industry specific areas of work system. Another aspect of the disclosure elaborates a complexities system corresponding to and deriving from the capabilities system, and further a complexity granularities system deriving from the complexities system. The disclosure explains yet another aspect where an employer-developed capability matrix system and a candidate-developed capability matrix system, where both the systems use the complexity granularities system. Also described is a system of pre-determined weights for the capabilities and the complexities at various granularities coupled to an intelligent searching and mapping system, which is further coupled to the employer-developed capability matrix system, the candidate-developed capability matrix system, and also coupled to the processor to compute scores. Further a compatibility ranked list system uses the computed scores from the intelligent searching and mapping system, to generate the compatibility ranked list.

### BRIEF DESCRIPTION OF THE DRAWINGS

For a more complete understanding of the present invention and the advantages thereof, reference is now made to the following descriptions taken in connection with the accompanying drawings in which:

FIG. 1 depicts a system 100 for computing a compatibility ranked list for an application for two generic entities;

FIG. 2 is a flow chart 200 that explains a method for computing a compatibility ranked list for an application, corresponding to the system depicted in FIG. 1;

FIG. 3 and FIG. 3A are to be referred to in conjunction for understanding the system embodied in the disclosure. FIG. 3 describes a system 300 for computing a compatibility ranked list, for at least an employer and at least a candidate of an industry and FIG. 3A is a simple data hierarchy 300A of industry, capability, complexity and granularity;

FIG. 4 is a flow chart 400 that explains a method for computing a compatibility ranked list for at least an employer and at least a candidate from an industry; Table 1 explains the evolution of industry, industry specific area of work, and the capabilities and complexity hierarchy;

FIG. 5 depicts an exemplary view of how an employer can see a compatibility ranked list of candidates using cue cards;

FIG. 6 shows a compatibility matrix of a candidate with respect to a job role; and

FIG. 7 presents another view using compatibility ranked list for comparing various candidates using charts.

### DETAILED DESCRIPTION

The present disclosure describes a system and a method for computing compatibility ranked list using an intelligent capability matrix. In an embodiment, the present disclosure describes the system and the method for computing the compatibility ranked list for at least an employer and at least a candidate, using the intelligent capability matrix. The capability matrix comprises a set of pre-defined parameters to distinguish, identify and validate aspects of capabilities and complexities, for both the employer and the candidate side. The set of pre-defined parameters also take into account demonstrated capabilities. The system could also be a computer readable medium, functionally coupled to a memory, where the computer readable medium is configured to implement the exemplary steps of the method. The system can be implemented as a stand-alone solution, as a Software-as-a-Service (SaaS) model or a cloud solution or any combination thereof. The disclosure describes the steps of an employer defining a capability map and role requirements represented by complexity at varied granularity; providing a common capability grid representing the capability and complexity and translating the skills and experience of a candidate to the capability grid, and then doing a quantification of the mapping between the candidate and the requirement.

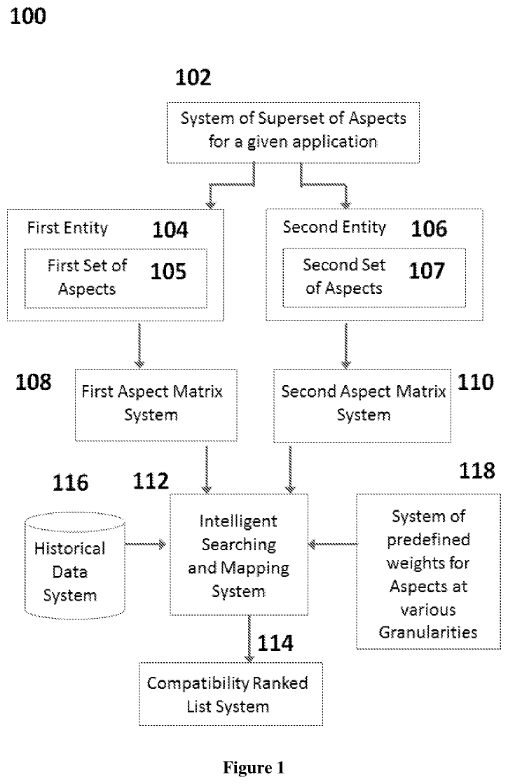

FIG. 1 depicts a generic system (100) for computing a compatibility ranked list for an application with a corresponding system of superset of aspects (102) with different granularities. The system (100) further includes a plurality of first entity (104) having a first set of aspects (105) selected from the superset of aspects (102) and a plurality of second entity (106) having a second set of aspects (107) selected from the superset of aspects (102), wherein the plurality of first entity (104) and the plurality of second entity (106) are associated with the application. These aspects may be attributes that the entities possess or desire. In an exemplary manner, we could look at the plurality of first entity (104) as providers and the plurality of second entity (106) as consumers. In yet another example, we could look at the plurality of first entity (104) and the plurality of second entity (106) as multiple candidates or commodities or services to be compared and contrasted. FIG. 1 further shows a first aspect matrix system (108) using the different granularities of the first set of aspects (105) of the plurality of the first entity (104), and a second aspect matrix system (110) using the different granularities of the second set of aspects (107) of the plurality of the second entity (106). An intelligent searching and mapping system (112) is functionally coupled to both the first aspect matrix system (108) and the second aspect matrix system (110), to compute scores which are used by a compatibility ranked list system (114) to generate the compatibility ranked list. These scores could be calculated in linear or non-linear fashion.

FIG. 1 further shows a historical data system (116) that stores historically stored data about at least one selected from the set comprising the first set of aspects (105) with corresponding granularities, the second set of aspects (107) with corresponding granularities and the superset of aspects (102) with different granularities corresponding to the application, wherein the historical data system (116) is functionally coupled to the intelligent searching and mapping system (112). Also shown is a pre-determined weights system (118) of providing pre-determined weights for both: the first set of aspects (105) and the second set of aspects (107); wherein the pre-determined weights system (118) is functionally coupled to the intelligent searching and mapping system (112).

FIG. 1 then elaborates that the first set of aspects (105), the second set of aspects (107) and the corresponding granularities; and the pre-determined weights for both sets: the first set of aspects (105) and the second set of aspects (107), are obtained using either external data, the historical data system (116) or an expert system. Further described is the intelligent searching and mapping system (112) that can use methods selected from statistical methods, numerical methods, expert systems based methods, artificial intelligence based methods, machine learning methods and any combination thereof, for computing scores which are then used by the compatibility ranked list system (114) to generate the compatibility ranked list.

Three examples for the system (100) described in FIG. 1 are illustrated below:

Example 1: As the first example, we consider “Talent Management” as an application in a typical company. The plurality of first entity (104) may be particular management positions or employers having a first set of aspects (105) such as ‘people management skills’ and ‘leadership’. The plurality of second entity (106) may be employees/technical persons in the same company, having a second set of aspects (107) including technical experience and client facing role experience and/or certain aspects of people management skills and/or leadership. The first capability matrix system (108) would, in this case, define a capability matrix for the expectation in a managerial role and a second capability matrix system (110) in this case would define a capability matrix for the technical employee who aspires to work in managerial role, wherein both the capability matrix systems (108) and (110) use same or different granularities of the first set of aspects (105) and the second set of aspects (107). An intelligent searching and mapping system (112) will evolve a score between the first aspect matrix system (108) and the second aspect matrix system (110), based on numerical match. These scores will generate a ranked list in the compatibility ranked list system (114) based on the score as a function of data from both the first capability matrix system (108) and the second capability matrix system (110).

Example 2: As the second example, we consider a typical “Matrimonial Portal” as an application. The plurality of first entity (104) may be a set of brides having a first set of aspects (105) such as socializing, cooking, career aspirations, hobbies etc. Within the aspect of socializing, there may be granularities like socializing in small groups or large groups, with known people or unknown people, on an occasional basis or frequently etc. Or within the aspect of cooking, there may be granularities like cooking for a small family or a large group, staple food or global delicacies etc. The plurality of second entity (106) is a set of grooms having a second set of aspects (107) including socializing, cooking, career aspirations, hobbies etc. The first capability matrix system (108) would, in this case, define a capability matrix for the bride role and a second capability matrix system (110) in this case would define a capability matrix for the groom role, wherein both the capability matrix systems (108) and (110) use same or different granularities of the first set of aspects (105) and the second set of aspects (107). An intelligent searching and mapping system (112) will evolve a ranked list in the compatibility ranked list system (114) based on the score calculated from the data from both the first capability matrix system (108) and the second capability matrix system (110).

Example 3: As the third example, we consider a typical “Materials Management Portal” or even “Procurement Portal”. The plurality of first entity (104) may be consumer having a first set of aspects (105) such as specifics of quality and quantity of material/commodity required etc. Within the aspects of quantity of material/commodity, there may be granularities like small or large quantity, bulk or batch-wise dispatch etc. The plurality of second entity (106) is providers having a second set of aspects (107) including qualities and quantities of commodity/material. The first capability matrix system (108) would, in this case, define a capability matrix for the requirement commodity/material and a second capability matrix system (110) in this case would define a capability matrix for the supplier's material/commodity, wherein both the capability matrix systems (108) and (110) use same or different granularities of the first set of aspects (105) and the second set of aspects (107). An intelligent searching and mapping system (112) will evolve a ranked list in a compatibility ranked lists system (114) based on the score calculated on the basis of the data from both the first capability matrix system (108) and the second capability matrix system (110).

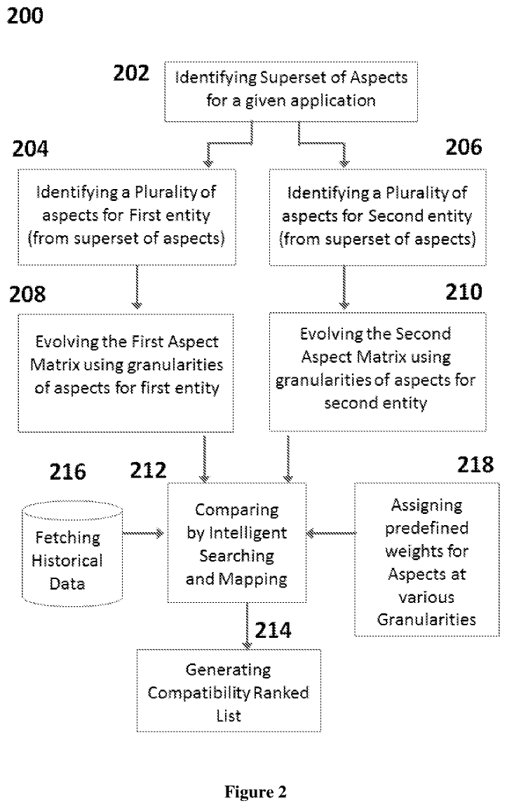

We now refer to FIG. 2 which describes a flowchart for various steps of a method (200) for computing a compatibility ranked list for an application. This method (200) is consistent with the system (100) described in FIG. 1, and is explained in conjunction with components of the system (100). Step (202) describes identifying the superset of aspects (102) with different granularities for the application. Taking example of Procurement as an example, the superset of aspects (102) is quality and quantity of material. Step (204) then describes identifying the plurality of first entity (104) having the first set of aspects (105) selected from the superset of aspects (102). As an example, the first entity (104) could be a provider. Step (206) then describes identifying the plurality of second entity (106) having the second set of aspects (107) selected from the superset of aspects (102), wherein the plurality of first entity (104) and the plurality of second entity (106) are associated with the application. The exemplary second entity (106) could be a consumer. Step (208) describes the first aspect matrix system (108) evolving a first aspect matrix using the different granularities of the first set of aspects (105) of the plurality of the first entity (104), and step (210) describes the second aspect matrix system (110) evolving a second aspect matrix using the different granularities of the second set of aspects (107) of the plurality of the second entity (106). These matrixes for provider and consumer could be about material, strength, cost and durability of commodity. Step (212) describes comparing the first aspect matrix and the second aspect matrix by intelligent searching and mapping using the intelligent searching and mapping system (112), to compute scores such as how much is the numerical match between what is expected by the consumer and provided by the provider. These scores could be linear/non-linear matches. Based on the scores between various providers, for different qualities and possibly quantities of commodity desired by the consumer, a relative ranking is obtained. This is described in step (214) as generating the compatibility ranked list in the compatibility ranked list system (114) using the computed scores. Step (216) describes fetching historical data about the set comprising the first set of aspects (105) with corresponding granularities, the second set of aspects (107) with corresponding granularities and superset of aspects (102) with different granularities corresponding to the application. Step (218) elaborates assigning a set of pre-determined weights using the pre-determined weights system (118) for the first set of aspects (105) and the second set of aspects (107); wherein the pre-determined weights are used also by the intelligent searching and mapping.

The first set of aspects (105), the second set of aspects (107) and the corresponding granularities; and the pre-determined weights for both sets: the first set of aspects (105) and the second set of aspects (107), are obtained using either external data, the historical data or an expert system, and the intelligent searching and mapping system (112) uses methods selected from statistical methods, numerical methods, expert systems based methods, artificial intelligence based methods, machine learning methods and any combination thereof, for computing scores which are then used by the compatibility ranked list system (114) to generate the compatibility ranked list.

### Example Embodiments

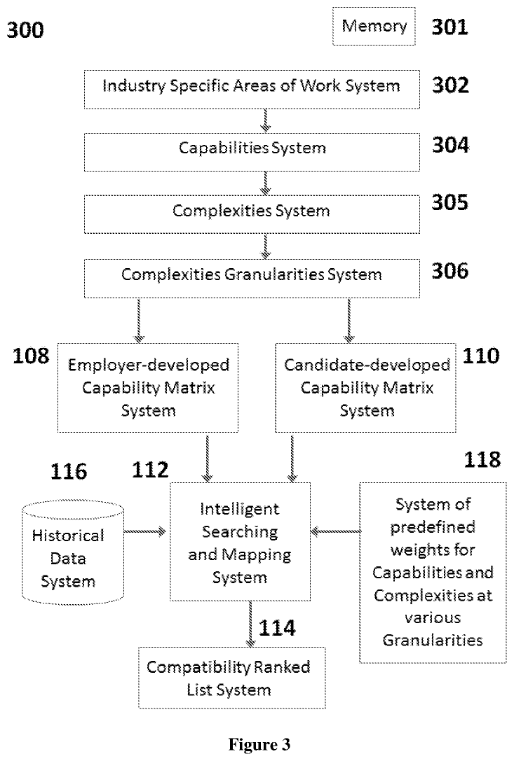

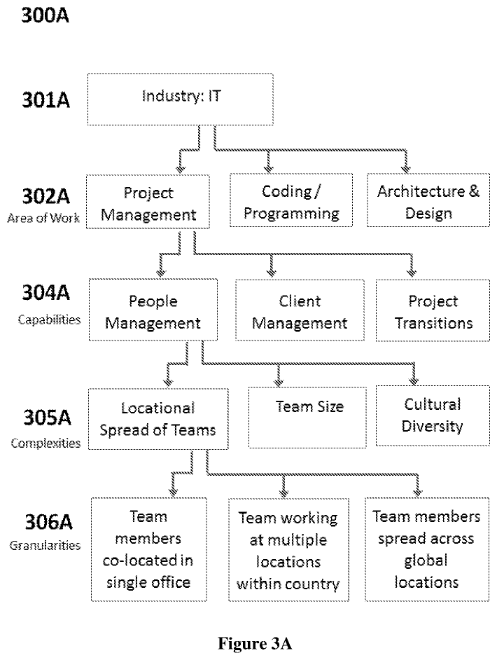

We now refer to FIG. 3 and FIG. 3A in conjunction for understanding the generic and exemplary models. FIG. 3 describes a system (300) for computing a compatibility ranked list, for at least an employer and at least a candidate of an industry and FIG. 3A is a simple data hierarchy (300A) of industry, capability, complexity and granularity.

System (300) as described in FIG. 3 is an instance of the system (100) described in FIG. 1, and hence corresponding system blocks are numbered consistently wherever applicable even though they are specific in FIG. 3 compared to FIG. 1.

FIG. 3 describes a system (300) for computing a compatibility ranked list, for at least an employer and at least a candidate of an industry, and the system (300) includes at least a processor and a memory (301). The memory (301) and the processor are functionally coupled to each other, and the system (300) further includes an industry specific areas of work system (302), corresponding to the industry. Taking example of ‘IT’ (301A) as an industry shown (amongst others such as Retail, banking, or manufacturing, not shown in the figure), one could think of ‘technical architecture and design’ or ‘coding/programming’ (or ‘IT Support’, ‘business analysis’; both not shown in the figure) as examples of industry specific areas of work (302A) shown in data hierarchy (300A). In an exemplary manner we can consider ‘project management’ as yet another area of work. Referring again to FIG. 3, the system (300) further depicts a capabilities system (304) deriving from the industry specific areas of work system (302). Referring now to FIG. 3A, for the ‘project management’ (302A) as an exemplary area of work, we can consider ‘people management’ (304A) as a capability. Other possible capabilities could easily be ‘project transitions’, ‘client management’ etc. Again referring to FIG. 3, Complexities System (305) is corresponding to and deriving from the capabilities system (304). FIG. 3A shows an example as locational spread of teams' (305A) as complexity for ‘people management’ capability (304A). Other examples of complexity for “people management” could be “Team Size” or “Cultural Diversity”. FIG. 3 further shows that by drilling down on the complexities system (305), a complexity granularities system (306) is depicted which derives from the complexities system (305). FIG. 3A now shows as an example where one could think of ‘team members co-located’ (306A) as different granularities for the ‘location spread of teams’ complexity (305A). Other examples could be ‘teams working at multiple locations in country’ or ‘teams located globally’.

Now referring only to FIG. 3, an employer-developed capability matrix system (108) and a candidate-developed capability matrix system (110), both the systems using the complexity granularities system (306), are described. Both the systems are instances of the first aspect matrix system (108) and the second aspect matrix system (110) of FIG. 1. FIG. 3 further describes a system of pre-determined weights for the capabilities and the complexities at various granularities (118) which is used to allocate weights to vary relative importance of capabilities and complexities. FIG. 3 further describes an intelligent searching and mapping system (112) coupled to the employer-developed capability matrix system (108), the candidate-developed capability matrix system (110), the system of pre-determined weights for capabilities and complexities at various granularities (118) and also coupled to the processor to compute scores. The scoring is based on the relative numerical match between what is expected of a candidate by an employer and what is provided by the candidates. As an example, if more than three years of experience is required by the employer and the candidate brings only one year of experience, the score is 33%. Similar contributions to various requirements coupled with their relative weights are used to arrive at a composite score. FIG. 3 then describes a compatibility ranked list system (114) that uses the computed scores from the intelligent searching and mapping system (112), to generate the compatibility ranked list.

FIG. 3 also describes a historical data system (116) comprising historically stored data about the industry specific areas of work and corresponding capabilities, complexities corresponding to the capabilities, the granularities of the complexities, and the set of pre-determined weights for capabilities and complexities. The historical data system (116) is functionally coupled to the intelligent searching and mapping system (112).

The plurality of industry specific areas of work, the corresponding plurality of capabilities, the plurality of complexities corresponding to the identified plurality of capabilities, the granularities to pre-determined levels of the plurality of complexities; and the set of pre-determined weights for capabilities and complexities at various granularities are obtained using either external data, the historical data system (116) or an expert system.

The intelligent searching and mapping system (112) uses methods selected from statistical methods, numerical methods, expert systems based methods, artificial intelligence based methods, machine learning methods and any combination thereof.

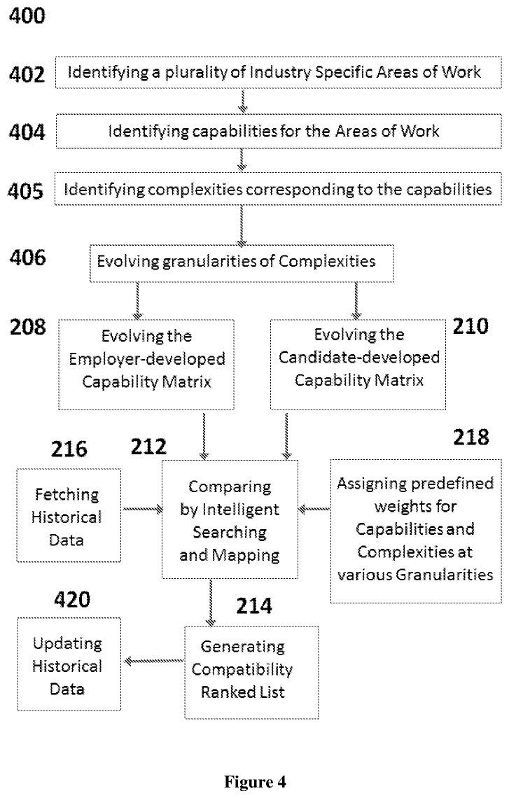

Referring to FIG. 4, a flowchart describing a method (400) for computing a compatibility ranked list for at least an employer and at least a candidate from an industry, is described. Method (400) described in FIG. 4 is an instance of the generic method (200) described in FIG. 2, and hence corresponding steps are numbered consistently wherever applicable, even though they are specific in FIG. 4 compared to FIG. 2. The method (400) is consistent with the system (300) described in FIG. 3, and is explained in conjunction with components of the system (300).

Step (402) describes identifying a plurality of industry specific areas of work, corresponding to the industry using the industry specific areas of work system (302). Taking example of “IT” industry, industry specific area could be “Project Management” or “Coding”. Step (404) further describes identifying a plurality of capabilities, corresponding the identified plurality of industry specific areas of work using the capabilities system (304). Example of capability could be that of “Client Management” for the “Project Management” as area of work. Step (405) describes identifying a plurality of complexities corresponding to the identified plurality of capabilities by the complexities system (305). Example of this could be under “Client Management” as capability, “Client Size” could be a complexity. Subsequently, step (406) describes evolving granularities to pre-determined levels of the identified plurality of complexities by the complexity granularities system (306). Example of granularity for “Client Size” as complexity is “at least 500+ employees”.

Step (208) then shows evolving an employer-developed capability matrix using the granularities of the complexities and step (210) shows evolving a candidate-developed capability matrix, using the granularities of the complexities by the employer-developed capability matrix system (108) and the candidate-developed capability matrix system (110) respectively of FIG. 3. Step (218) further describes assigning a set of pre-determined weights for the capabilities and the complexities at various granularities using the system of pre-determined weights for the capabilities and the complexities at various granularities (118). Step (212) then depicts comparing the employer-developed capability matrix and the candidate-developed capability matrix, by intelligent searching and mapping using the intelligent searching and mapping system (112) of FIG. 3, to compute scores. The scores depend on relative weights and numerical match. Pre-determined weights could take relative weights as a percentage scale. As an example, one could look at giving more relative weightage to “people management”, say 40%, as a capability than say “client management” which may have 10% weightage or say ‘project transitions’ which may have 15% weightage. Another example may give more weightage to “client size” complexity than ‘history with client’. Yet another example may give more weightage to the granularity of ‘less than 500 employees’ than the granularity of ‘hostile client’. Yet another example is given in Table 1 as shown below:

TABLE 1
An illustration of constructing a grid for capabilities and complexities with associated granularities

| | Industry | | | |
|---|---|---|---|---|
| | IT Industry | | | |
| | Area of work | | | |
| | Training | | | |
| Capability | Complexity | Degree of Complexity | | |
| Training | Nature of training | Enrolment of participants for | Clearly identified performance | Team Performance Problem not clearly |
| Needs | requirement | Standard/Routine training courses | problem with customisations needed | defined so efforts needed to study the |
| Analysis | | | to standard L&D offerings | job environment |
| | Source of Inputs | Inputs from participant's line | Inputs gathered from multiple | Inputs gathered from customers |
| | | manager | stakeholders in the organisation | impacted by the paricipant's |
| | | | | knowledge & skills |
| | Level of | Standard course topics where | Course topics where content needs to | Course topics where standard/ |
| | Standardization | reference content is available | be curated & compiled from variety of | available content can't be used and |
| | | | sources | content needs to be created |
| | Responsibility for | Course Effectiveness feedback | Change in Job Behaviour resulting in | Measurable benefits in Training Rol |
| | outcome | after few weeks | improved on-the-job performance | |
| Training | Type of Participant | Instructor led training with | Handholding on assignments in | On-the-job support for applying the |
| Delivery | Interaction | specific delivery objectives | classroom/lab environment | learning in real life situations |
| | Learning | Instructor Led | Use of assignments & case studies | Experiential learning through |
| | Methodology used | | | evaluations & personal feedbacks |
| | Type of | Entry level & Junior Level | Managerial Level of employees | Senior Management and Leaders |
| | Participants | employees | | |
| | Participant | Homogeneous/similar background | Heterogeneous/different cultural | Multi racial/Multi Ethnic |
| | Diversity handled | | strata | |
| | Course | Standard training courses and | Customised content to suit audience | Conceptual trainings with no standard |
| | Standardization | contents | | content |
| | Nature of | Use of Slides & printed handouts | Use of Multimedia/AV learning aids | Use of Interactive Learning Media |
| | Training Contents | | | |
| | Training | Physically co-located participants | Remote participants using | Training imparted using platforms |
| | Environment | in face-to-face environment | collaborative platforms like interactive | based on Augmented Reality/Virtual |
| | | | webinars, video conferencing etc | Reality |
| | Session Size | Upto 15 participants in a single | 15 to 30 participants in a single session | Above 30 participants in a single |
| | | session | | session |

Table 1 describes industry as “IT Industry”, ‘area of work’ as ‘training’, and various capabilities such as ‘Training Needs Analysis’; and ‘Training Delivery’ and complexities within ‘Training Needs Analysis’ such as ‘level of Standardization’, ‘Responsibility for outcome’ etc. Within the complexity of “Level of Standardization”, we can see as an example, three levels/granularities such as ‘Standard topic reference available’, ‘content curation required from multiple sources, and ‘content unavailable and needs creation’.

Step (214) further describes generating the compatibility ranked list using the computed scores from the intelligent searching and the mapping system (112). Step (216) describes that the intelligent searching and mapping further includes fetching historical data about at least one selected from the set comprising the industry specific areas of work and corresponding capabilities, complexities corresponding to the capabilities and the granularities of the complexities; and the set of pre-determined weights for capabilities and complexities. Step (420) then describes updating the historical data, which is stored within the historical data system (116) of FIG. 3, with the computed compatibility ranked list in the compatibility ranked list system (114).

FIG. 4 also describes that the plurality of industry specific areas of work, the corresponding plurality of capabilities, the plurality of complexities corresponding to the identified plurality of capabilities, the granularities to pre-determined levels of the plurality of complexities, and the set of pre-determined weights for capabilities and complexities at various granularities are obtained using either external data, historical data or an expert system. Further, the intelligent searching and mapping comprises methods are selected from statistical methods, numerical methods, expert systems based methods, artificial intelligence based methods, machine learning methods and any combination thereof.

The method (400) provides the employer with the ranked list of candidates using on the intelligent capability matrixes and the compatibility ranked list is based on compatibility of each candidate with the job profile in context of the search conducted by the employer.

The system (300) provides the candidate with the compatibility ranked list of job profiles using on the intelligent capability matrices and the compatibility ranked list is based on compatibility of the candidate with each job profile in context of the capabilities. A similar ranked list is equally possible for a candidate to see from a set of employers, since the mechanism of comparing and contrasting is available using the same intelligent mapping.

The candidate as well as the employer, both, get to see the precise matches and mismatches between the desired versus the available capabilities. They can also see the degree of mismatch if any. Based on the compatibility ranked list the candidate can compare multiple job profiles at a granular level at a glance. Based on the compatibility ranked list the employer can compare multiple candidates at a granular level at a glance.

Thus, the systems (100) and the method (200) in accordance with the present disclosure are deployable across a plurality of platforms using heterogeneous server and storage farms spread across geographies for better availability and high response time.

The systems (100) and the method (200) are deployable using multiple hardware and integration options, such as, for example, cloud infrastructure, standalone solutions mounted on mobile hardware devices, third-party platforms and system solutions etc. and is advantageously facilitated to be validated using biometric and electric verifications like e-KYC (Know Your Customer).

The ranked list can be represented in multiple formats like Cue-Card, graphs, charts, and various interactive visual representations.

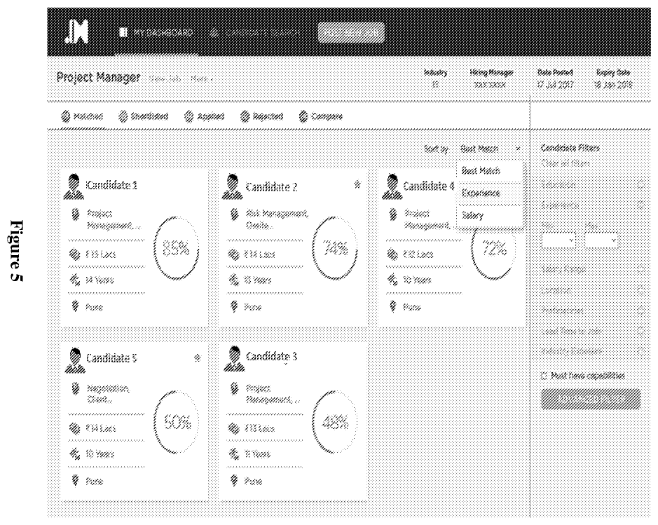

FIG. 5 depicts an exemplary view of how an employer can see a compatibility ranked list of candidates using cue cards. It is seen in the FIG. 5 that for the “Project Manager” as a position, we have various candidates such as candidate 1 at 85% match, candidate 2 at 74% match and candidate 3 at 48% match and so on.

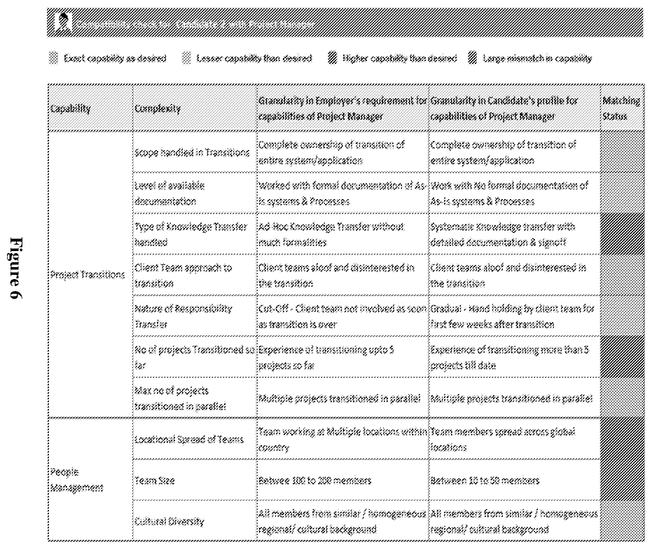

FIG. 6 shows a compatibility matrix of a candidate with respect to a job role. As an example, we see compatibility check for candidate 2 as a candidate for the position of Project Manager. It will be seen that there are four different colors: Dark Green, Green, Amber and Red indicating various degrees of match and mismatch. As an example, under “Project Transitions” as a capability, for “Scope handled in transitions”, the candidate seems to have adequate compatibility and is shown in green color. In another example for “Level of available documentation”, the candidate has lesser compatibility and is shown in amber color. In yet another example, “Type of knowledge transfer handled”, the candidate has more than adequate compatibility and is shown in dark green color. In yet another example under the capability of “People Management”, there is a large mismatch of compatibility and is shown in red color.

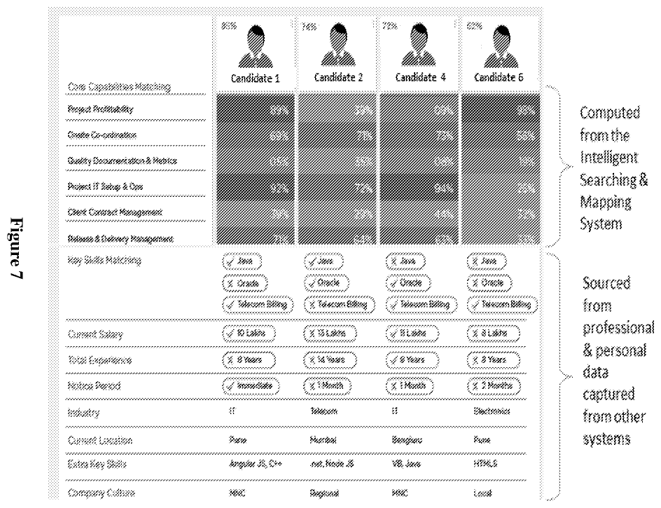

FIG. 7 presents another view using compatibility ranked list for comparing various candidates using charts. As an example, we see the break-up of various capabilities/complexities based comparison chart for four candidates: candidate 1, candidate 2, candidate 4 and candidate 6. We see overall matching between expected capabilities and complexities for the desired position and the capabilities and complexities that these four candidates bring to the table. Not only these, but the granularity of each of those capabilities and complexities is shown, making it apparent to the recruiter as to how the selection can be made. The Compatibility ranked list suggests that candidate 1 is the best amongst the lot with 85% matching and candidate 6 is the lowest with 62% match. There is additional data also matched such as “salary”, “notice period” etc. Typically, these are the factors those seem to be considered in making a selection, whereas in the disclosure those parameters are also considered but more focus is given to the capability/complexity grid with appropriate relative weights.

There are several advantages of the compatibility ranked list using intelligent capability matrix. One advantage is that the common platform for employer and the candidates whereby communication gap is reduced. The other advantage is that there is less dependence on interpretation of both requirements and skills, since the reliance on resume.CV from candidate side and that on JD from the employer's side is almost none. Yet another advantage is that there is more objectivity in the selection process which results into improved conversion ratio between short listed candidates and final selection. Another advantage is the reduction in time and cost for the entire recruitment cycle. Even though the advantages are described for recruitment, the same can be harnessed for, not limited to, talent management, career progression, training and like.

1. A system for computing a compatibility ranked list for an application with a corresponding system of superset of aspects with different granularities, the system comprising:
a plurality of first entity having a first set of aspects selected from the superset of aspects;
a plurality of second entity having a second set of aspects selected from the superset of aspects wherein the plurality of first entity and the plurality of second entity are associated with the application;
a first aspect matrix system using the different granularities of the first set of aspects of the plurality of the first entity;
a second aspect matrix system using the different granularities of the second set of aspects of the plurality of the second entity;
an intelligent searching and mapping system functionally coupled to both the first aspect matrix system and the second aspect matrix system to compute scores; and
a compatibility ranked list system that uses the computed scores to generate the compatibility ranked list.

2. The system as claimed in claim 1, further comprising:
a historical data system comprising historically stored data about at least one selected from the set comprising first set of aspects with corresponding granularities, the second set of aspects with corresponding granularities and the superset of aspects with different granularities corresponding to the application, wherein the historical data system functionally coupled to the intelligent searching and mapping system; and
a pre-determined weights system of providing pre-determined weights for both: the first set of aspects and the second set of aspects; wherein the pre-determined weights system is functionally coupled to the intelligent searching and mapping system.

3. The system as claimed in claim 2, wherein:
the first set of aspects, the second set of aspects and the corresponding granularities; and the pre-determined weights for both sets: the first set of aspects and the second set of aspects, are obtained using either external data, the historical data system or an expert system; and
the intelligent searching and mapping system uses methods selected from statistical methods, numerical methods, expert systems based methods, artificial intelligence based methods, machine learning methods and any combination thereof.

4. A method for computing a compatibility ranked list for an application, the method comprising the steps of:
identifying a superset of aspects with different granularities for the application;
identifying a plurality of first entity having a first set of aspects selected from the superset of aspects;
identifying a plurality of second entity having a second set of aspects selected from the superset of aspects, wherein the plurality of first entity and the plurality of second entity are associated with the application;
evolving a first aspect matrix using the different granularities of the first set of aspects of the plurality of the first entity;
evolving a second aspect matrix using the different granularities of the second set of aspects of the plurality of the second entity;
comparing the first aspect matrix and the second aspect matrix by intelligent searching and mapping, to compute scores; and
generating the compatibility ranked list using the computed scores.

5. The method as claimed in claim 4, further comprising:
fetching historical data about at least one selected from the set comprising the first set of aspects with corresponding granularities, the second set of aspects with corresponding granularities and the superset of aspects with different granularities corresponding to the application; and
assigning a set of pre-determined weights for the first set of aspects and the second set of aspects; wherein the pre-determined weights are used also by the intelligent searching and mapping.

6. The method as claimed in claim 5, wherein:
the first set of aspects, the second set of aspects and the corresponding granularities; and the pre-determined weights for both sets: the first set of aspects and the second set of aspects, are obtained using either external data, the historical data or an expert system; and
wherein the intelligent searching and mapping uses methods selected from statistical methods, numerical methods, expert systems based methods, artificial intelligence based methods, machine learning methods and any combination thereof.

7. A system for computing a compatibility ranked list, for at least an employer and at least a candidate of an industry, the system comprising at least a processor and a memory wherein the memory and the processor are functionally coupled to each other, the system further comprising:
an industry specific areas of work system corresponding to the industry;
a capabilities system deriving from the industry specific areas of work system;
a complexities system corresponding to and deriving from the capabilities system;
a complexity granularities system deriving from the complexities system;
an employer-developed capability matrix system and a candidate-developed capability matrix system both the systems using the complexity granularities system;
a system of pre-determined weights for the capabilities and the complexities at various granularities;
an intelligent searching and mapping system coupled to the employer-developed capability matrix system the candidate-developed capability matrix system the system of pre-determined weights for capabilities and complexities at various granularities and also coupled to the processor to compute scores; and
a compatibility ranked list system using the computed scores from the intelligent searching and mapping system, to generate the compatibility ranked list.

8. The system as claimed in claim 7, further comprising:
a historical data system comprising historically stored data about at least one selected from the set comprising the industry specific areas of work and corresponding capabilities, complexities corresponding to the capabilities, the granularities of the complexities; and the set of pre-determined weights for capabilities and complexities, wherein the historical data system is functionally coupled to the intelligent searching and mapping system.

9. The system as claimed in claim 8, wherein:
the plurality of industry specific areas of work, the corresponding plurality of capabilities, the plurality of complexities corresponding to the identified plurality of capabilities, the granularities to pre-determined levels of the plurality of complexities;
and the set of pre-determined weights for capabilities and complexities at various granularities are obtained using either external data, the historical data system or an expert system; and
the intelligent searching and mapping system uses methods selected from statistical methods, numerical methods, expert systems based methods, artificial intelligence based methods, machine learning methods and any combination thereof.

10. A method for computing a compatibility ranked list for at least an employer and at least a candidate from an industry, comprising the steps of:
identifying a plurality of industry specific areas of work, corresponding to the industry;
identifying a plurality of capabilities, corresponding the identified plurality of industry specific areas of work;
identifying a plurality of complexities corresponding to the identified plurality of capabilities;
evolving granularities to pre-determined levels of the identified plurality of complexities;
evolving an employer-developed capability matrix using the granularities of the complexities;
evolving a candidate-developed capability matrix, using the granularities of the complexities;
assigning a set of pre-determined weights for the capabilities and the complexities at various granularities;
comparing the employer-developed capability matrix and the candidate-developed capability matrix, by intelligent searching and mapping, to compute scores; and
generating the compatibility ranked list using the computed scores from the intelligent searching and the mapping.

11. The method as claimed in 10, wherein the intelligent searching and mapping further comprising:
fetching historical data about at least one selected from the set comprising the industry specific areas of work and corresponding capabilities, complexities corresponding to the capabilities and the granularities of the complexities; and the set of pre-determined weights for capabilities and complexities.

12. The method as claimed in claim 10, further comprising:
updating the historical data with the computed compatibility ranked list.

13. The method as claimed in claim 10, wherein:
the plurality of industry specific areas of work, the corresponding plurality of capabilities, the plurality of complexities corresponding to the identified plurality of capabilities, the granularities to pre-determined levels of the plurality of complexities; and the set of pre-determined weights for capabilities and complexities at various granularities are obtained using either external data, the historical data or an expert system; and
wherein the intelligent searching and mapping comprises methods selected from statistical methods, numerical methods, expert systems based methods, artificial intelligence based methods, machine learning methods and any combination thereof.
